(19) United States
(12) Patent Application Publication
(10) Pub. No.: US 2026/0368176 A1
(43) Pub. Date: Nov. 19, 2026

(54) DATA PROCESSING METHOD AND ELECTRONIC DEVICE

(71) Applicant: Lenovo (Beijing) Limited, Beijing (CN)

(72) Inventors: Weikang WANG, Beijing (CN); Haiyang LIU, Beijing (CN); Xin ZHOU, Beijing (CN)

(21) Appl. No.: 19/673,333

(22) Filed: May 11, 2026

(30) Foreign Application Priority Data
May 19, 2025 (CN) 202510645935.3

(51) Int. Cl. G06F 16/2455; G06F 16/334

(52) U.S. Cl. CPC G06F 16/24552; G06F 16/3347

(57) ABSTRACT

A data processing method includes obtaining kv data corresponding to each of a plurality of target document groups, selecting, from one target document group of the plurality of target document groups, first X consecutive characters as target characters, and sequentially updating kv data corresponding to each of the target characters. The kv data is obtained by performing independent calculation on each of the plurality of target document groups, and the plurality of target document groups are sequentially connected. X is a positive integer greater than or equal to 1, and is smaller than a quantity of characters included in the one target document group.

### CROSS-REFERENCE TO RELATED APPLICATION

This application claims priority to Chinese Patent Application No. 202510645935.3, filed on May 19, 2025, the entire content of which is incorporated herein by reference.

### TECHNICAL FIELD

The present disclosure relates to the technical field of data processing, and in particular, to a data processing method and an electronic device.

### BACKGROUND

During use of a large language model based on Retrieval-augmented Generation (RAG), RAG retrieves associated document blocks according to a user question, and the large language model calculates vector data in a key-value pair form for the document blocks and the user question and performs content generation.

In order to improve efficiency of the large language model, a cache pool is set for document blocks, such that the large language model does not need to calculate vector data of the document blocks in real time, and can directly read the vector data from the cache pool and provide the vector data to the large language model for directly performing content generation.

However, vector data of each document block in the cache pool is obtained by performing independent calculation on the document block, such that the vector data provided to the large language model cannot represent contextual association relationships among the document blocks, resulting in inaccurate results generated by the large language model.

### SUMMARY

In accordance with the present disclosure, there is provided a data processing method including obtaining kv data corresponding to each of a plurality of target document groups, selecting, from one target document group of the plurality of target document groups, first X consecutive characters as target characters, and sequentially updating kv data corresponding to each of the target characters. The kv data is obtained by performing independent calculation on each of the plurality of target document groups, and the plurality of target document groups are sequentially connected. X is a positive integer greater than or equal to 1, and is smaller than a quantity of characters included in the one target document group.

Also in accordance with the present disclosure, there is provided an electronic device including a memory storing a computer program and data generated during operation of the computer program, and a processor. The processor is configured to execute the computer program to obtain kv data corresponding to each of a plurality of target document groups, select, from one target document group of the plurality of target document groups, first X consecutive characters as target characters, and sequentially update kv data corresponding to each of the target characters. The kv data is obtained by performing independent calculation on each of the plurality of target document groups, and the plurality of target document groups are sequentially connected. X is a positive integer greater than or equal to 1, and is smaller than a quantity of characters included in the one target document group.

Also in accordance with the present disclosure, there is provided a non-transitory computer-readable storage medium storing an application program that, when executed by a processor, causes an electronic device including the processor to obtain kv data corresponding to each of a plurality of target document groups, select, from one target document group of the plurality of target document groups, first X consecutive characters as target characters, and sequentially update kv data corresponding to each of the target characters. The kv data is obtained by performing independent calculation on each of the plurality of target document groups, and the plurality of target document groups are sequentially connected. X is a positive integer greater than or equal to 1, and is smaller than a quantity of characters included in the one target document group.

### BRIEF DESCRIPTION OF THE DRAWINGS

In order to more clearly illustrate the technical solutions of the embodiments of the present disclosure, the accompanying drawings for description of the embodiments will be briefly introduced below. The accompanying drawings in the following description are merely some embodiments of the present disclosure, for those skilled in the art, other drawings can be obtained from these drawings without any creative effort.

FIG. 1 is a flowchart of a data processing method consistent with the present disclosure.

FIG. 2 schematically shows the end-to-end connection among target document groups consistent with the present disclosure.

FIG. 3 schematically shows the kv data corresponding to target document groups consistent with the present disclosure.

FIG. 4 schematically shows the Euclidean distances between a manner of calculating kv data by combining document blocks and a manner of combining kv data after independent calculation.

FIG. 5 schematically shows target characters in the target document group consistent with the present disclosure.

FIG. 6 schematically shows target characters in target document groups consistent with the present disclosure.

FIG. 7 is a partial flowchart of a data processing method consistent with the present disclosure.

FIG. 8 schematically shows neighboring document blocks forming target document groups consistent with the present disclosure.

FIG. 9 is another partial flowchart of a data processing method consistent with the present disclosure.

FIG. 10 schematically shows an example of serial loading and recalculation consistent with the present disclosure.

FIG. 11 schematically shows another example of serial loading and recalculation consistent with the present disclosure.

FIG. 12 schematically shows parallel loading and recalculation consistent with the present disclosure.

FIG. 13 is a structural schematic diagram of a data processing apparatus consistent with the present disclosure.

FIG. 14 is a structural schematic diagram of an electronic device consistent with the present disclosure.

FIG. 15 schematically shows implementing content generation in a use scenario of a large language model based on RAG consistent with the present disclosure.

FIG. 16 schematically shows recalculating kv data of some tokens in a use scenario of a large language model based on RAG consistent with the present disclosure.

FIG. 17 schematically shows iteratively calculating kv data of some tokens in each document in a use scenario of a large language model based on RAG consistent with the present disclosure.

FIG. 18 schematically shows parallel loading and recalculation in a use scenario of a large language model based on RAG consistent with the present disclosure.

### DETAILED DESCRIPTION OF THE EMBODIMENTS

The technical solutions in the embodiments of the present disclosure will be described below with reference to the accompanying drawings in the embodiments of the present disclosure. The described embodiments are merely some embodiments of the present disclosure rather than all embodiments. All other embodiments obtained by those skilled in the art based on the embodiments in the present disclosure without creative effort shall fall within the scope of the present disclosure.

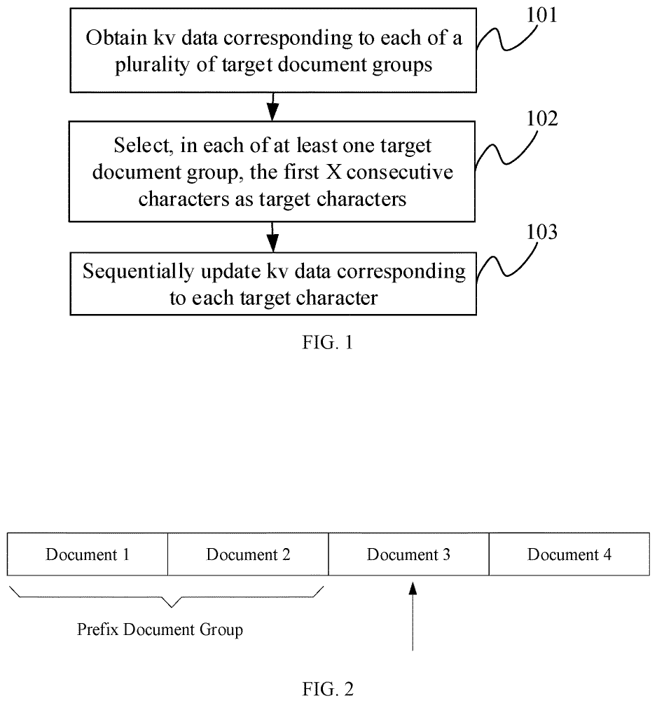

FIG. 1 is an implementation flowchart of a data processing method in the present disclosure. The method can be applied to an electronic device capable of performing data processing, such as a mobile phone, a tablet device, a notebook computer, or a server. The technical solution in the present disclosure is mainly used to reduce an amount of computation for obtaining kv data, thereby improving computational efficiency.

Specifically, the method in the present disclosure includes the following.

In operation 101, kv data corresponding to each of a plurality of target document groups is obtained.

The kv data is data obtained by performing independent calculation on the target document groups. The kv data is vector data stored in a key-value pair form of key plus value. The target document groups are sequentially connected. For example, as shown in FIG. 2, four target document groups are respectively document group 1, document group 2, document group 3, and document group 4, and the target document groups are connected end to end through characters included therein. Except for the target document group positioned first, other target document groups each have a prefix document group. For example, taking document group 3 as an example, document group 1 and document group 2 are prefix document groups.

In some embodiments, kv data corresponding to each target document group in operation 101 may be read from a cache pool.

The cache pool includes kv data obtained by performing independent calculation on documents through an intelligent model. In view of this, in operation 101, kv data corresponding to the target document groups is searched in the cache pool according to the target document groups, and after the kv data is found, the kv data corresponding to the target document groups is read out.

In some embodiments, in operation 101, kv data calculation may be respectively performed on each target document group through the intelligent model, so as to obtain kv data corresponding to each target document group.

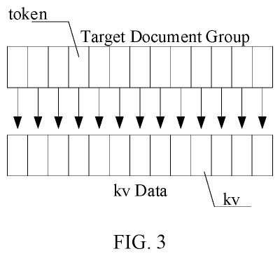

The intelligent model is a machine learning model capable of calculating kv data of characters. A document group may be converted into a plurality of characters, and the characters may also be referred to as tokens, such as words, single characters, phrases, or the like. The kv data corresponding to the document group is composed of kv data corresponding to each character token converted from the document group, as shown in FIG. 3.

In operation 102, first X consecutive characters in each of at least one target document group are selected as target characters.

X is a positive integer greater than or equal to 1, and X is smaller than a quantity of characters included in the corresponding target document group. That is, in the present disclosure, some characters in the target document group are selected as target characters, and the target characters are the first X consecutive characters in the target document group.

Differences exist between kv data calculated after combining a plurality of target document groups and kv data obtained by independently performing kv calculation on the plurality of target document groups and then combining the kv data.

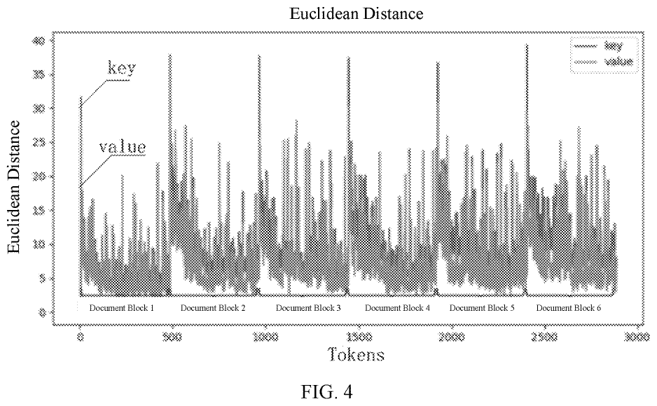

For example, as shown in FIG. 4, taking six document blocks as an example, full-precision prefix kv data and independent kv data are respectively generated based on the same six document blocks. The prefix kv data is kv data obtained by connecting the six document blocks end to end, combining the six document blocks, and then integrally performing kv calculation. The independent kv data is obtained by respectively performing independent kv calculation on the six document blocks and then combining the calculated kv data. In view of this, Euclidean distances between the two types of kv data are calculated. The Euclidean distances include distances between keys in the kv data (as shown in portions at upper ends of lines in FIG. 4), and distances between values in the kv data (as shown in portions at lower ends of lines in FIG. 4). A horizontal axis is an index of character tokens in the document blocks, and a vertical axis is Euclidean distances of keys and values under the two calculation manners. The differences between the manner of calculating kv data by combining document blocks and the manner of combining kv data after independent calculation may be reflected as follows:

Inside each document block, kv data of a small number of character tokens located at a starting position will have relatively large differences under the two calculation manners, while differences under the two calculation manners for most character tokens located in middle portion and ending portion of the document block are relatively small. As shown in FIG. 4, Euclidean distances of key data of character tokens located at the starting position in document block 2 under the two calculation manners are obviously greater than Euclidean distances of key data of character tokens located at later middle and ending position in document block 2; and Euclidean distances of value data of character tokens located at the starting position in document block 2 under the two calculation manners are obviously greater than Euclidean distances of value data of character tokens located at later middle and ending position in document block 2.

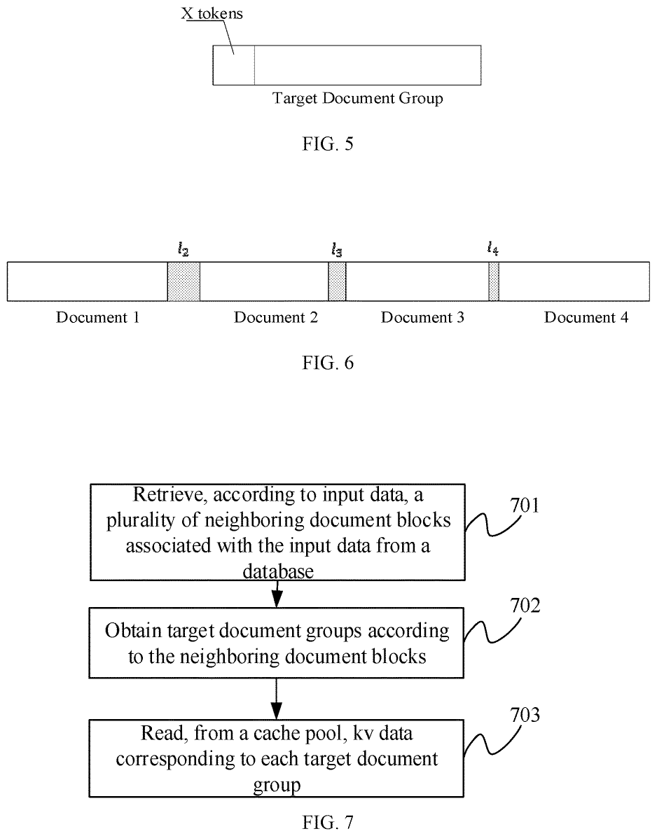

In view of this, in the present disclosure, the first X consecutive characters in the target document groups are selected as target characters. As shown in FIG. 5, kv data corresponding to the target characters has relatively large differences compared with kv data obtained by combining all target document groups and performing kv calculation.

In operation 103, kv data corresponding to each target character is sequentially updated.

Specifically, in the present disclosure, kv calculation may be sequentially performed on the target characters through the intelligent model, so as to obtain kv data corresponding to the target characters.

Further, in the present disclosure, after operation 103, all target document groups (where at least one target document group has X target characters updated respectively) may be provided to an intelligent model such as a Large Language Model (LLM), and the intelligent model performs content generation processing such as text generation or image generation at least according to the target document groups, so as to obtain target content.

It can be seen from the above technical solutions that, in the data processing method provided in the embodiments of the present disclosure, for kv data obtained by performing independent calculation on document groups, kv data may be recalculated for some characters positioned earlier among the document groups, and kv data does not need to be recalculated for other characters in the document groups, such that while ensuring accuracy of the kv data, an amount of computation for kv calculation can be reduced, thereby improving efficiency of obtaining accurate kv data.

In some embodiments, when kv data corresponding to each target character is updated in operation 103, a prefix document group corresponding to the target character may first be determined. The prefix document group corresponding to the target character includes all target document groups positioned before the target document group in which the target character is located. Then, kv data corresponding to the target character is recalculated based on kv data corresponding to the prefix document group.

For example, as shown in FIG. 6, taking four document groups as an example, document 1, document 2, document 3, and document 4 are each composed of a plurality of tokens. For document 2, document 3, and document 4, target characters l₂, l₃, and l₄ therein respectively correspond to prefix document groups. A prefix document group corresponding to the target character l₂ in document 2 is document 1, a prefix document group corresponding to the target character l₃ in document 3 is document 1 and document 2, and a prefix document group corresponding to the target character l₄ in document 4 is document 1, document 2, and document 3. In view of this, in the present embodiment, for the target character l₂ in document 2, the prefix document group, namely document 1, is determined, and kv calculation is performed on the target character l₂ in document 2 according to kv data corresponding to document 1, so as to obtain kv data corresponding to the target character l₂; for the target character l₃ in document 3, the prefix document groups, namely document 1 and document 2, are determined, and kv calculation is performed on the target character l₃ in document 3 according to kv data corresponding to document 1 and kv data corresponding to document 2, so as to obtain kv data corresponding to the target character l₃; and for the target character l₄ in document 4, the prefix document groups, namely document 1, document 2, and document 3, are determined, and kv calculation is performed on the target character l₄ in document 4 according to kv data corresponding to document 1, kv data corresponding to document 2, and kv data corresponding to document 3, so as to obtain kv data corresponding to the target character l₄.

As described above, the target document group in which the target character is located includes: any target document group other than the target document group positioned first among the plurality of target document groups. That is, target characters do not need to be selected from the target document group positioned first, and the target document groups from which target characters are selected do not include the target document group positioned first.

For example, as shown in FIG. 6, target characters are respectively selected from document 2, document 3, and document 4. Since document 1 does not have a prefix document group, kv recalculation does not need to be performed, and therefore target characters may not be selected from document 1.

Further, in a case that the prefix document group includes target characters, kv data corresponding to the target characters in the prefix document group has already been recalculated.

In the present disclosure, when kv data corresponding to target characters is recalculated, kv data corresponding to the target characters is recalculated sequentially according to a connection sequence among the target document groups and an order of characters in the target document groups. In view of this, as kv data corresponding to the target characters is calculated, if target characters exist in prefix document groups corresponding to target characters for which kv data is recalculated later, then kv data corresponding to these target characters is recalculated first.

For example, as shown in FIG. 6, for the target character l₂ in document 2, document 1 is determined as the prefix document group. Since document 1 does not include selected target characters, kv calculation is directly sequentially performed on each target character l₂ in document 2 according to kv data corresponding to document 1, so as to obtain kv data corresponding to the target character l₂; for the target character l₃ in document 3, namely document 1 and document 2 are determined as the prefix document groups. Document 2 includes selected target characters l₂, but kv data corresponding to these target characters l₂ has already been recalculated. At this time, according to kv data corresponding to document 1 and kv data corresponding to document 2 (where selected target characters l₂ in document 2 have already been recalculated), kv calculation is sequentially performed on each target character l₃ in document 3, so as to obtain kv data corresponding to the target character l₃; for the target character l₄ in document 4, document 1, document 2, and document 3 are determined as the prefix document groups. Document 2 includes selected target characters l₂, but kv data corresponding to these target characters l₂ has already been recalculated, and document 3 includes selected target characters l₃, but kv data corresponding to these target characters l₃ has already been recalculated. At this time, according to kv data corresponding to document 1, kv data corresponding to document 2 (where selected target characters l₂ in document 2 have already been recalculated), and kv data corresponding to document 3 (where selected target characters l₃ in document 3 have already been recalculated), kv calculation is sequentially performed on each target character l₄ in document 4, so as to obtain kv data corresponding to the target character l₄.

Based on the above implementation solution, according to the Euclidean distances shown in FIG. 4, differences between the manner of calculating kv data by combining document blocks and the manner of combining kv data after independent calculation may further be reflected as follows:

Deviations of kv data combined after independent calculation increase as a quantity of previously superimposed document blocks increases.

For example, as shown in FIG. 4, a Euclidean distance of key data of a character token located at a certain position in document block 6 under the two calculation manners is greater than a Euclidean distance of key data of a character token located at the same position in document block 4 under the two calculation manners.

In view of this, in the present disclosure, quantities of target characters included in different target document groups may be different. That is, for target document groups at different positions, quantities of selected target characters are different. In a specific implementation, a quantity of target characters in a target document group positioned earlier is greater than a quantity of target characters in a target document group positioned later (i.e., a preceding target document group has more target characters than a subsequent target document group).

For example, as shown in FIG. 6, a quantity of target characters l₂ in document 2 is greater than a quantity of target characters l₃ in document 3, and a quantity of target characters l₃ in document 3 is greater than a quantity of target characters l₄ in document 4.

In a specific implementation, in adjacently positioned target documents, quantities of included target characters present a linear variation relationship based on a maximum value and a minimum value.

The maximum value is an upper-limit quantity value of target characters included in one target document group, and the minimum value is a lower-limit quantity value of target characters included in one target document group. The maximum value and the minimum value may be preset according to needs. The maximum value is represented by lₘₐₓ, and the minimum value is represented by lₘᵢₙ. In view of this, in the present disclosure, a difference value between the maximum value and the minimum value may be used as a slope of the linear variation relationship. Specifically, as shown in Formula (1):

$${l}_{n} = {l}_{max} - ( {l}_{n} - {l}_{max} ) \frac{n - 2}{N - 2} \qquad ( 1 )$$

where, lₙ is a quantity of characters selected as target characters in the nth target document group, and N is a total quantity of target document groups.

It can be seen that, in the present disclosure, a difference value between the maximum value and the minimum value is used as a slope to construct a target function representing a linear variation relationship. The target function uses a position of a target document group among all target document groups as an independent variable, and uses a quantity of characters selected as target characters as a dependent variable. Therefore, through the target function, a quantity X of characters selected as target characters in each target document group can be determined, and then the first X consecutive characters in the target document group are selected as target characters, thereby recalculating kv data corresponding to these target characters.

Based on the above implementation solution, in an implementation manner, when kv data corresponding to each of a plurality of target document groups is obtained in operation 101, the kv data may be obtained through the following manner, as shown in FIG. 7.

Operation 701, according to input data, a plurality of neighboring document blocks associated with the input data are retrieved from a database.

The database includes a plurality of document blocks to be retrieved. The input data is data input by a user when using the intelligent model for text generation or image generation, such as text, images, or the like. In the present disclosure, document blocks satisfying association conditions with the input data, namely neighboring document blocks, are retrieved from the database based on the input data.

The association condition may be that: a Euclidean distance between the input data and the neighboring document blocks is less than or equal to a corresponding threshold, or a similarity between the input data and the neighboring document blocks is greater than or equal to a corresponding threshold.

Operation 702, target document groups are obtained according to the neighboring document blocks.

A target document group is composed of at least one neighboring document block. In the present disclosure, neighboring document blocks may be combined to obtain a plurality of target document groups. For example, after 10 neighboring document blocks are retrieved, the first neighboring document block and the second neighboring document block are concatenated into document 1, the third neighboring document block is used as document 2, the fourth neighboring document block, the fifth neighboring document block, and the sixth neighboring document block are concatenated into document 3, and the seventh neighboring document block, the eighth neighboring document block, the ninth neighboring document block, and the tenth neighboring document block are concatenated into document 4. Document 1, document 2, document 3, and document 4 are respectively target document groups.

Operation 703: kv data corresponding to each target document group is read from a cache pool.

A maximum quantity of neighboring document blocks included in a target document group is determined based on a size of kv data corresponding to characters and a maximum storage space of the cache pool. The cache pool includes kv data obtained by performing independent calculation on documents through the intelligent model. Documents corresponding to kv data included in the cache pool may be document blocks in the database or document groups formed by concatenating document blocks.

It can be seen that, in the present disclosure, kv data corresponding to document groups is pre-stored in the cache pool. After target document groups are obtained, corresponding kv data may be directly searched from the cache pool, and the intelligent model does not need to perform kv data calculation on the target document groups in real time, thereby reducing calculation duration, accelerating a rate of providing kv data to the intelligent model, and improving content generation efficiency of the intelligent model.

A quantity of document blocks concatenated in document groups corresponding to kv data included in the cache pool is limited, so as to avoid excessive occupation of space in the cache pool due to excessively large kv data corresponding to document groups obtained from excessive concatenation of document blocks. In view of this, a maximum quantity is set in the present disclosure, and a quantity of neighboring document blocks included in any target document group does not exceed the maximum quantity.

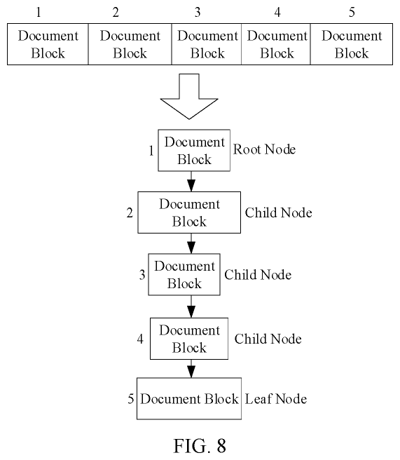

In some embodiments, a document group composed of a plurality of document blocks is stored in a tree form, as shown in FIG. 8. A document block concatenated at a first position is a root node of the tree, a document block concatenated at a second position is a child node of the root node, and a document block concatenated at a third position is a child node of the child node of the root node, and so on. A document block concatenated at a last position is a leaf node of the tree. A quantity of document blocks in the document group, namely a depth D of the tree, is limited and does not exceed a preset maximum quantity. For example, a maximum value of D is shown in Formula (2):

$${D}_{max} \approx [ {log}_{M} \frac{{B}_{max}}{α B} ] \qquad ( 2 )$$

where, Dₘₐₓ is a maximum depth of the tree, α is a preset coefficient, and Bₘₐₓ is a maximum storage space of the cache pool; B is a maximum value of a size of kv data corresponding to a single character. M is a quantity of document blocks in the database.

It can be seen that, in the present disclosure, a quantity of concatenated document blocks in document groups may be limited, so as to avoid excessive occupation of space in the cache pool, thereby enabling the cache pool to reserve kv data of more document groups.

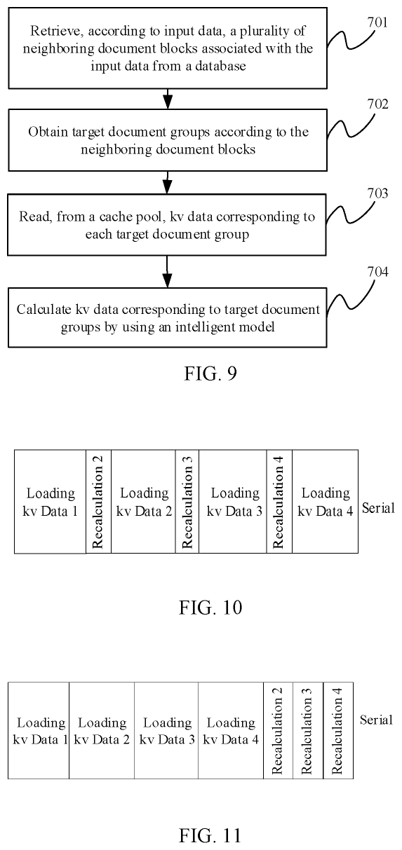

Based on the above implementation solution, in the present disclosure, in a case that kv data corresponding to the target document groups is not read from the cache pool in operation 703, the following processing may further be included, as shown in FIG. 9:

Operation 704, kv data corresponding to the target document groups is calculated by using the intelligent model.

That is, if kv data corresponding to the target document groups is not pre-stored in the cache pool, the intelligent model is used for real-time calculation.

Further, in the present disclosure, after operation 704, the calculated kv data corresponding to the target document groups may be stored into the cache pool for subsequent searching.

It can be seen that, in the present disclosure, kv data in the cache pool may be continuously updated, thereby accelerating efficiency of subsequent kv data acquisition and improving efficiency of content generation performed by the intelligent model.

In a specific implementation manner, as shown in FIG. 10, after kv data corresponding to characters in a target document block is read from the cache pool in the present disclosure, the kv data is loaded into a target storage area, and kv data corresponding to a next character continues to be read from the cache pool and loaded into the target storage area until kv data corresponding to a target character is read from the cache pool. After kv data corresponding to the target character is recalculated according to kv data already loaded into the target storage area, the recalculated kv data is loaded into the target storage area, and then kv data corresponding to subsequent other characters continues to be read from the cache pool and loaded into the target storage area. In this process, loading kv data corresponding to each character (including the target character) into the target storage area and recalculating kv data are serially implemented.

In a specific implementation manner, as shown in FIG. 11, in the present disclosure, kv data corresponding to each character (including target characters) in each target document block is sequentially read from the cache pool and loaded into the target storage area. After loading is completed, kv data corresponding to the target characters is recalculated according to kv data already loaded into the target storage area. In this process, loading kv data corresponding to each character (including the target characters) into the target storage area and recalculating kv data are serially implemented.

In another implementation manner, in the present disclosure, when kv data corresponding to target documents is read from the cache pool, the read kv data may be loaded into a target storage area, such as a video memory area. That is, in the present disclosure, kv data read from the cache pool is loaded into the target storage area. In view of this, when kv data corresponding to target characters is updated in operation 103, kv data corresponding to the target characters in the target storage area is updated sequentially for the target characters loaded into the target storage area.

Further, updating kv data corresponding to the target characters in the target storage area and loading, into the target storage area, kv data corresponding to other characters positioned after the updated target characters are executed in parallel.

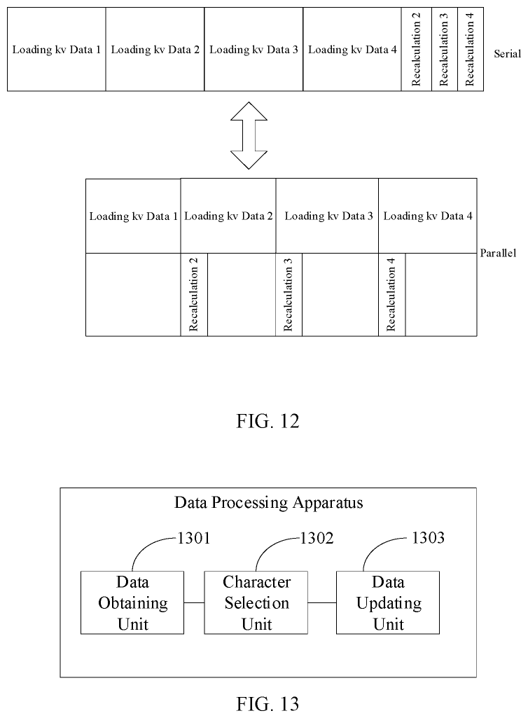

In a specific implementation, as shown in FIG. 12, after kv data corresponding to characters in a target document block is read from the cache pool in the present disclosure, the kv data is loaded into the target storage area, and kv data corresponding to a next character continues to be read from the cache pool and loaded into the target storage area until kv data corresponding to a target character is read from the cache pool and loaded into the target storage area. Kv data corresponding to the target character in the target storage area is recalculated according to kv data already loaded into the target storage area, while kv data corresponding to subsequent other characters continues to be read from the cache pool and loaded into the target storage area in parallel. In this process, loading kv data corresponding to each character (including the target character) into the target storage area and recalculating kv data loaded into the target storage area are implemented in parallel.

It can be seen that, in the present disclosure, loading kv data corresponding to a current character and recalculating kv data corresponding to loaded target characters are executed in parallel, thereby accelerating a rate of loading accurate kv data into the target storage area and improving efficiency of content generation performed by the intelligent model.

FIG. 13 is a structural schematic diagram of a data processing apparatus in the present disclosure. The apparatus may be applied to an electronic device capable of performing data processing, such as a mobile phone, a tablet device, a notebook computer, or a server. The technical solution in the present disclosure is mainly used to reduce an amount of computation for obtaining kv data, thereby improving computational efficiency.

Specifically, the apparatus in the present disclosure includes the following units:

A data obtaining unit 1301, configured to obtain kv data corresponding to each of a plurality of target document groups, the kv data being kv data obtained by performing independent calculation on the target document groups, the target document groups being sequentially connected.

A character selection unit 1302, configured to, in at least one target document group, respectively select the first X consecutive characters as target characters, X being a positive integer greater than or equal to 1, and X being smaller than a quantity of characters included in the corresponding target document group.

A data updating unit 1303, configured to sequentially update kv data corresponding to each target character.

It can be seen from the above technical solutions that, in the data processing apparatus provided in the embodiments of the present disclosure, for kv data obtained by performing independent calculation on document groups, kv data may be recalculated for some characters positioned earlier among the document groups, and kv data does not need to be recalculated for other characters in the document groups, such that while ensuring accuracy of the kv data, an amount of computation for kv calculation can be reduced, thereby improving efficiency of obtaining accurate kv data.

In some embodiments, when updating kv data corresponding to the target characters, the data updating unit 1303 is specifically configured to: determine prefix document groups corresponding to the target characters, the prefix document groups including all target document groups positioned before the target document group in which the target characters are located, and recalculate kv data corresponding to the target characters based on kv data corresponding to the prefix document groups.

The target document group in which the target characters are located includes: any target document group other than a target document group positioned first among the plurality of target document groups. In a case that the prefix document groups include the target characters, kv data corresponding to the target characters in the prefix document groups has already been recalculated.

In some embodiments, quantities of the target characters included in different target document groups are different. A quantity of the target characters in target document groups positioned earlier is greater than a quantity of the target characters in target document groups positioned later.

In some embodiments, in the adjacently positioned target documents groups, quantities of the included target characters present a linear variation relationship based on a maximum value and a minimum value. The maximum value is an upper-limit quantity value of the target characters included in one target document group, and the minimum value is a lower-limit quantity value of the target characters included in one target document group.

In some embodiments, when obtaining kv data corresponding to each of a plurality of target document groups, the data obtaining unit 1301 is specifically configured to: retrieve, according to input data, a plurality of neighboring document blocks associated with the input data from a database; obtain the target document groups according to the neighboring document blocks, the target document groups being composed of at least one neighboring document block; and read, from a cache pool, kv data corresponding to each target document group. A maximum quantity of neighboring document blocks included in the target document groups is determined based on a size of kv data corresponding to characters and a maximum storage space of the cache pool.

In a case that kv data corresponding to the target document groups is not read from the cache pool, the data obtaining unit 1301 is further configured to: calculate kv data corresponding to the target document groups by using the intelligent model.

Further, after calculating kv data corresponding to the target document groups by using the intelligent model, the data obtaining unit 1301 is further configured to: store the calculated kv data corresponding to the target document groups into the cache pool.

Specifically, kv data read from the cache pool is loaded into a target storage area.

In view of this, the data updating unit 1303 is specifically configured to: sequentially update kv data corresponding to the target characters in the target storage area for the target characters loaded into the target storage area; where updating kv data corresponding to the target characters in the target storage area and loading, into the target storage area, kv data corresponding to other characters positioned after the updated target characters are executed in parallel.

Specific implementation manners of the units in the present disclosure may refer to corresponding contents described above, and details are not described herein again.

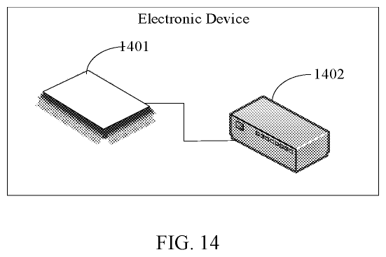

FIG. 14 is a structural schematic diagram of an electronic device in the present disclosure, and the electronic device includes the following structures:

A memory 1401, configured to store a computer program and data generated during execution of the computer program;

A processor 1402, configured to execute the computer program to implement: obtaining kv data corresponding to each of a plurality of target document groups, the kv data being kv data obtained by performing independent calculation on the target document groups, the target document groups being sequentially connected, in at least one target document group, respectively selecting the first X consecutive characters as target characters, X being a positive integer greater than or equal to 1, X being smaller than a quantity of characters included in the corresponding target document group, and sequentially updating kv data corresponding to each target character.

It can be seen from the above technical solutions that, in the electronic device provided in the embodiments of the present disclosure, for kv data obtained by performing independent calculation on document groups, kv data may be recalculated for some characters positioned earlier among the document groups, and kv data does not need to be recalculated for other characters in the document groups, such that while ensuring accuracy of the kv data, an amount of computation for kv calculation can be reduced, thereby improving efficiency of obtaining accurate kv data.

Taking a use scenario of a large language model based on RAG as an example, the technical solutions of the present disclosure are exemplarily described below:

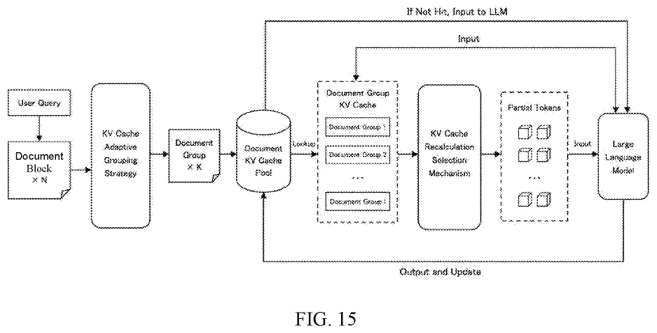

FIG. 15 is an overall flow of the technical solutions of the present disclosure. For an input question of a user (namely the input data described above), the most relevant N document blocks (namely the neighboring document blocks described above) are first retrieved through a vector database (namely the database described above), and K document groups (namely the target document groups described above; in a case that each target document group includes only one neighboring document block, K is the same as N) are generated through kv cache grouping. Afterwards, corresponding kv caches (namely kv data) are searched in a kv cache pool based on the document groups. If a kv cache of a document group exists, the kv cache is directly read. If the kv cache does not exist, the kv cache of the document group is generated through a large language model and stored into the cache pool. After kv cache reading is completed, some tokens that need recalculation are obtained through a prior-knowledge-guided kv cache recalculation selection mechanism, and the tokens are input into the large language model. By re-prefilling these tokens, a kv cache with restored precision (namely accuracy) is obtained. Finally, the kv cache with restored precision and the input question of the user are input into the large language model together, so as to obtain a final generation result.

Based on the flow shown in FIG. 15, the technical solutions of the present disclosure have the following technical points:

### 1. Prior-Knowledge-Guided Kv Cache Recalculation Token Selection:

In the technical solutions of the present disclosure, by summarizing distribution rules of kv cache deviations in independent documents (documents for performing independent calculation on kv data), as shown in FIG. 4, a prior-knowledge-guided kv cache recalculation selection mechanism is proposed for improving generation quality of a model and reducing additional computation overhead. Specific solutions are as follows:

### 1) Document-Block Kv Cache Recalculation Token Selection:

Based on findings from FIG. 4, the recalculation token selection strategy of the technical solutions of the present disclosure mainly includes two key points:
(1) A small number of tokens at a starting position of each document block (namely the target document groups described above) have relatively great influence on calculation results, and therefore these tokens are directly selected for recalculation.
(2) Precision loss caused by kv caches of preceding independent documents accumulates to subsequent document blocks, and therefore the more forward a position of a document block is, the greater a quantity of tokens that need recalculation is.

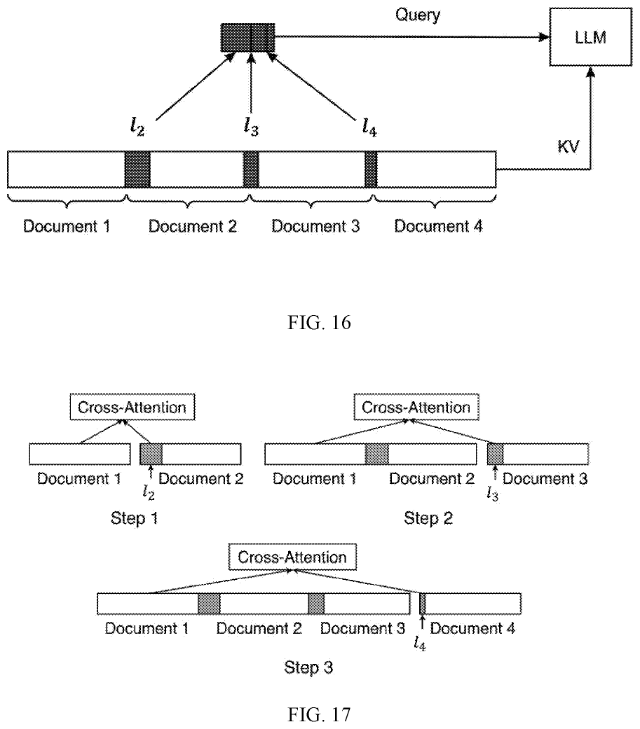

Based on the above observations, for an nth document block, assuming that a total quantity of tokens that need kv data recalculation is lₙ, lₙ tokens at the beginning of the document block are selected for recalculation. As n becomes larger, lₙ is set to be smaller, thereby reducing deviation accumulation caused by the previous n−1 independent document blocks. Specifically, as shown in FIG. 16, for a document block located at a first position, recalculation is not performed since the document block does not have precision loss. For subsequent N−1 document blocks, proportions of recalculated tokens gradually decrease. The present disclosure allocates quantities of recalculated tokens for each document block through a linear function as shown in Formula (1), and these tokens form queries to be provided to the large language model for kv data recalculation.

lₘₐₓ and lₘᵢₙ represent quantities of recalculated tokens in a second document and a last document, respectively, and a quantity of recalculated tokens in documents located in middle portion gradually decreases as n increases. According to experimental analysis, in actual scenarios, selection ranges of lₘₐₓ and lₘᵢₙ are approximately about 10% to 20% of a total quantity of document tokens. That is, if a total quantity of tokens in a background document is 2000, a quantity of tokens need to be recalculated is approximately 200 to 400, and generation quality of a large model close to full-precision prefix cache may be achieved.

### 2) Recalculation Token Quantity Optimization:

In the technical solutions of the present disclosure, since a recalculation token selection rule is to select only a small portion of tokens at beginnings of discontinuous document blocks, the fewer the quantity of groups is, the fewer the quantity of discontinuous documents is, and the fewer the quantity of tokens that need recalculation is. Meanwhile, based on analysis, document grouping further improves RAG inference precision. Therefore, the technical solutions of the present disclosure use document grouping to further reduce a quantity of recalculation tokens. According to existing methods, prefix document kv caches may be stored using a tree structure. Therefore, the present disclosure controls a quantity of document groups by adaptively setting a depth D of a cache tree.

Assuming that there are M documents in the database, for a cache tree having a depth D, a maximum quantity of stored cache nodes is

$${\prod }_{d = 1}^{D} ( M - d - 1 ) .$$

Therefore, the greater the depth of the tree, the greater the storage space is needed. In the technical solutions of the present disclosure, the depth of the tree is adaptively set according to a total size of space allocated to kv cache. Relevant studies indicate that, in RAG scenarios, a portion of kv caches is frequently accessed. Therefore, the present disclosure sets a coefficient α for measuring a proportion of high-frequency caches. Assuming that an average kv cache size of each current document is B bytes, a maximum tree depth that may be set is estimated shown in Formula (2). Bₘₐₓ is a maximum space size allocable to kv cache.

### 2. Iterative Kv Cache Recalculation Process Optimization:

Based on the recalculation token selection strategy proposed in the technical solutions of the present disclosure, an entire recalculation process is optimized, so as to further improve RAG inference efficiency based on document kv caches.

### 1) Iterative Kv Cache Recalculation:

In the technical solutions of the present disclosure, for each document block, only a small portion of tokens at a beginning are selected for recalculation. Therefore, an iterative recalculation strategy may be adopted to further reduce computation overhead of the recalculation process, and a main flow thereof is shown in FIG. 17.

For a scenario having N background document blocks (namely neighboring document blocks), an iterative method is adopted to sequentially recalculate a small number of initial tokens of the second document block to the Nth document block. As shown in FIG. 17, first, initial l₂ tokens of document 2 are used as queries, and a kv cache of document 1 is used as keys and values, and cross attention calculation is reperformed to obtain updated kv caches of the l₂ tokens. Then, independent kv caches of remaining L₂-l₂ tokens of document 2 are directly concatenated after the recalculated tokens. Afterwards, updated kv caches of document 1 and document 2 are used as keys and values, and l₃ tokens at an initial position of document 3 are used as queries, so as to recalculate to obtain updated kv caches of the l₃ tokens. By analogy, the process continues until recalculation processes of all document blocks are completed.

It can be seen that, in the present disclosure, adopting the iterative recalculation strategy may further reduce recalculation overhead. Specifically, in a certain algorithm, a specified proportion of tokens is directly selected as queries, and kv caches of all document blocks are used as keys and values, where complexity of an attention calculation process is

$$( {\sum }_{n = 1}^{N} {l}_{n} ) ( {\sum }_{n = 1}^{N} {L}_{n} ) .$$

By adopting the iterative method of the present solution, lₙ tokens at each process only need to calculate attention with n−1 document blocks before the lₙ tokens, and calculation complexity is further reduced to

$$\text{?} [ {l}_{n} ( {\sum }_{i = 1}^{n - 1} {L}_{i} ) ] .$$

$$\text{?} \text{indicates text missing or illegible when filed}$$

### 2) Kv Cache Recalculation Process Optimization:

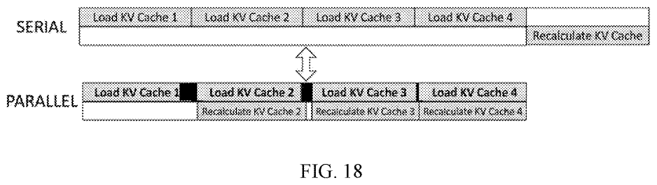

Since the technical solutions of the present disclosure adopt the iterative recalculation strategy, an entire recalculation process may be further optimized. A specific solution is shown in FIG. 18.

It can be seen that, for an existing recalculation method (an upper portion in FIG. 18), all kv caches, such as kv cache 1 (kv data of document 1), kv cache 2 (kv data of document 2), kv cache 3 (kv data of document 3), and kv cache 4 (kv data of document 4), need to be loaded into video memory before a subsequent recalculation process can begin, and therefore an additional portion of time overhead is added for recalculation. In the technical solutions of the present disclosure, since the iterative recalculation strategy is adopted (a lower portion in FIG. 18), a kv cache loading process and a partial recalculation process may overlap in time. Since a quantity of recalculation tokens in each iteration process is very small, recalculation time thereof is shorter than time for loading a complete document kv cache from another storage medium (such as a hard disk) into video memory. Therefore, in the present disclosure, during each loading process, whenever initial tokens that need recalculation are completely loaded, recalculation starts, while kv caches of remaining tokens that do not need recalculation are loaded in the background. Based on the optimized process, time consumption caused by recalculation may be reduced as much as possible, such that time efficiency close to that without recalculation may be achieved.

Each embodiment in the present specification is described in a progressive manner, and each embodiment mainly describes differences from other embodiments. Same or similar portions among the embodiments can be cross-referenced. For apparatuses disclosed in the embodiments, since the apparatuses correspond to methods disclosed in the embodiments, descriptions thereof are relatively simple, and for relevant information, reference can be made to descriptions in the method.

Those skilled in the art may further realize that various exemplary units and algorithm processes described in connection with the embodiments disclosed herein may be implemented by electronic hardware, computer software, or a combination thereof. In order to clearly illustrate interchangeability between hardware and software, compositions and processes of the examples have been generally described above according to functions. Whether the functions are executed in a hardware manner or a software manner depends on specific applications and design constraint conditions of the technical solutions. Those skilled in the art may use different methods for each specific application to implement the described functions, but such implementations should not be considered beyond the scope of the present disclosure.

Processes of methods or algorithms described in connection with the embodiments disclosed herein may be directly implemented by hardware, software modules executed by processors, or a combination thereof. The software modules may be placed in random access memory (RAM), memory, read-only memory (ROM), electrically programmable ROM, electrically erasable programmable ROM, registers, hard disks, removable disks, CD-ROMs, or any other forms of storage media well known in the technical field.

The above descriptions of the disclosed embodiments enable those skilled in the art to implement or use the present disclosure. Various modifications to these embodiments will be apparent to those skilled in the art, and general principles defined herein may be implemented in other embodiments without departing from the spirit or scope of the present disclosure. Therefore, the present disclosure is not limited to the embodiments shown herein, but is to accord with the widest scope consistent with principles and novel features disclosed herein.

What is claimed is:

1. A data processing method comprising:
obtaining kv data corresponding to each of a plurality of target document groups, the kv data being obtained by performing independent calculation on each of the plurality of target document groups, and the plurality of target document groups being sequentially connected;
selecting, from one target document group of the plurality of target document groups, first X consecutive characters as target characters, X being a positive integer greater than or equal to 1, and X being smaller than a quantity of characters included in the one target document group; and
sequentially updating kv data corresponding to each of the target characters.

2. The method according to claim 1, wherein sequentially updating the kv data corresponding to each of the target characters includes, for each target character:
determining prefix document groups corresponding to the target character, the prefix document groups including all target document groups before the one target document group; and
recalculating the kv data corresponding to the target character based on kv data corresponding to the prefix document groups.

3. The method according to claim 2, wherein:
the one target document group includes any target document group other than the first target document group among the plurality of target document groups; and
in a case that the prefix document groups include the target characters, the kv data corresponding to each of the target characters in the prefix document groups has already been recalculated.

4. The method according to claim 1, wherein quantities of target characters included in different ones of the plurality of target document groups are different, and a target document group positioned earlier has more target characters than a target document group positioned later.

5. The method according to claim 1, wherein, quantities of the target characters included in adjacently positioned target documents groups present a linear variation relationship based on a maximum value and a minimum value, the maximum value being an upper-limit quantity value of target characters included in a target document group, and the minimum value being a lower-limit quantity value of target characters included in a target document group.

6. The method according to claim 1, wherein obtaining the kv data corresponding to each of the plurality of target document groups includes, for each target document group:
retrieving, according to input data, a plurality of neighboring document blocks associated with the input data from a database;
obtaining the target document groups according to the plurality of neighboring document blocks, the target document group including at least one of the plurality of neighboring document blocks; and
reading, from a cache pool, the kv data corresponding to the target document group, a maximum quantity of neighboring document blocks included in the target document group being determined based on a size of kv data corresponding to characters and a maximum storage space of the cache pool.

7. The method according to claim 6, wherein obtaining the kv data corresponding to each of the plurality of target document groups further includes, in response to failing to read the kv data corresponding to one target document group from the cache pool:
calculating the kv data corresponding to the one target document group using an intelligent model.

8. The method according to claim 7, further comprising, after calculating the kv data corresponding to the one target document group using the intelligent model:
storing the kv data corresponding to the one target document group into the cache pool.

9. The method according to claim 6, wherein:
the kv data read from the cache pool is loaded into a target storage area; and
sequentially updating the kv data corresponding to each of the target characters includes:
sequentially updating, for target characters loaded into the target storage area, the kv data corresponding to each of the target characters in the target storage area; and
executing in parallel:
updating the kv data corresponding to each of the target characters in the target storage area, and
loading, into the target storage area, kv data corresponding to other characters positioned after the target characters are executed in parallel.

10. An electronic device comprising:
a memory storing a computer program and data generated during execution of the computer program; and
a processor configured to execute the computer program to:
obtain kv data corresponding to each of a plurality of target document groups, the kv data being obtained by performing independent calculation on each of the plurality of target document groups, and the plurality of target document groups being sequentially connected;
select, from one target document group of the plurality of target document groups, first X consecutive characters as target characters, X being a positive integer greater than or equal to 1, and X being smaller than a quantity of characters included in the one target document group; and
sequentially update kv data corresponding to each of the target characters.

11. The electronic device according to claim 10, wherein the processor is further configured to, when sequentially updating the kv data corresponding to each of the target characters, for each target character:
determine prefix document groups corresponding to the target character, the prefix document groups including all target document groups before the one target document group; and
recalculate the kv data corresponding to the target character based on kv data corresponding to the prefix document groups.

12. The electronic device according to claim 11, wherein:
the one target document group includes any target document group other than the first target document group among the plurality of target document groups; and
in a case that the prefix document groups include the target characters, the kv data corresponding to each of the target characters in the prefix document groups has already been recalculated.

13. The electronic device according to claim 10, quantities of target characters included in different ones of the plurality of target document groups are different, and a target document group positioned earlier has more target characters than a target document group positioned later.

14. The electronic device according to claim 10, wherein quantities of the target characters included in adjacently positioned target documents groups present a linear variation relationship based on a maximum value and a minimum value, the maximum value being an upper-limit quantity value of target characters included in a target document group, and the minimum value being a lower-limit quantity value of target characters included in a target document group.

15. The electronic device according to claim 10, wherein the processor is further configured to, when obtaining the kv data corresponding to each of the plurality of target document groups, for each target document group:
retrieve, according to input data, a plurality of neighboring document blocks associated with the input data from a database;
obtain the target document groups according to the plurality of neighboring document blocks, the target document group including at least one of the plurality of neighboring document blocks; and
read, from a cache pool, the kv data corresponding to the target document group, a maximum quantity of neighboring document blocks included in the target document group being determined based on a size of kv data corresponding to characters and a maximum storage space of the cache pool.

16. The electronic device according to claim 15, wherein the processor is further configured to, when obtaining the kv data corresponding to each of the plurality of target document groups, in response to failing to read the kv data corresponding to one target document group from the cache pool:
calculate the kv data corresponding to the one target document group using an intelligent model.

17. The electronic device according to claim 16, wherein the processor is further configured to, after calculating the kv data corresponding to the one target document group using the intelligent model:
store the kv data corresponding to the one target document group into the cache pool.

18. The electronic device according to claim 15, wherein:
the kv data read from the cache pool is loaded into a target storage area; and
the processor is further configured to, when sequentially updating the kv data corresponding to each of the target characters:
sequentially update, for target characters loaded into the target storage area, the kv data corresponding to each of the target characters in the target storage area; and
execute in parallel:
updating the kv data corresponding to each of the target characters in the target storage area, and
loading, into the target storage area, kv data corresponding to other characters positioned after the target characters are executed in parallel.

19. A non-transitory computer-readable storage medium storing an application program that, when executed by a processor, causes an electronic device including the processor to:
obtain kv data corresponding to each of a plurality of target document groups, the kv data being obtained by performing independent calculation on each of the plurality of target document groups, and the plurality of target document groups being sequentially connected;
select, from one target document group of the plurality of target document groups, first X consecutive characters as target characters, X being a positive integer greater than or equal to 1, and X being smaller than a quantity of characters included in the one target document group; and
sequentially update kv data corresponding to each of the target characters.

20. The storage medium according to claim 19, wherein the application program, when executed by the processor, further causes the electronic device to, when sequentially updating the kv data corresponding to each of the target characters, for each target character:
determine prefix document groups corresponding to the target character, the prefix document groups including all target document groups before the one target document group; and
recalculate the kv data corresponding to the target character based on kv data corresponding to the prefix document groups.
